(19) United States
(12) Patent Application Publication
(10) Pub. No.: US 2003/0150418 A1
(43) Pub. Date: Aug. 14, 2003

(54) Manufacturing pistons

(76) Inventor: Samantha Isobelle Barnes, Bilton (GB)

Correspondence Address: Robert L Stearns, 5291 Colony Drive North, Saginaw, MI, 48603, US

(21) Appl. No.: 10/311,680

(22) PCT Filed: Jun. 26, 2001
(86) PCT No.: PCT/GB01/02835

(30) Foreign Application Priority Data
Jun. 28, 2000 (GB) 0015689.3

(51) Int. Cl. F02F 1/00

(52) U.S. Cl. 123/193.6

(57) ABSTRACT

A piston for use in an internal combustion engine is manufactured by forming a blank (10, 50, 70) from a first material, providing a region (20, 60, 80) of a second material in a surface portion (12, 52, 54) of the blank (10, 50, 70), the second material being secured to said first material, and forming a recess (14, 28, 56, 68, 86) so that the recess has a bounding surface at least part of which is formed by the second material. The region (20, 60, 80) of the second material is formed and secured to the first material by inserting a tool (22) into the blank (10, 50, 70), bringing about relative reciporcating movement between the tool and the blank (10, 50, 70) so that frictional heat is generated plasticising the material adjacent to the tool, and by causing relative translational movement between the blank and the tool while continuing the reciprocating movement therebetween so that the tool (22) moves through said region (20, 60, 80), thereby forming the second material and mixing it with the first material at the edges of said region to secure the materials together.

This invention is concerned-with a method of manufacturing a piston for use in an internal combustion engine.

Pistons for use in internal combustion engines comprise a crown portion, a skirt portion, and a mounting portion on which a gudgeon pin is mounted, the gudgeon pin serving to connect the piston to a connecting rod of the engine. The crown portion has an upper surface which extends across a cylinder in which the piston makes reciprocating movement, being guided in its movement by the skirt portion of the piston. The upper surface of the crown portion borders a combustion chamber in which combustion events take place to drive the piston downwardly in its cylinder. Hence, the upper surface of the crown portion is subjected to high forces and temperatures caused by the combustion events. The side surface portion of the crown portion of the piston, ie the surface portion thereof which extends generally parallel to the. wall of the cylinder, defines one or more recesses in the form of grooves extending around the piston. These grooves are for containing piston rings which seal the gap between the piston and the wall of the cylinder. The side surface portion of the crown portion of the piston is also subjected to high forces and temperatures.

Pistons are usually manufactured by forming a blank, usually by casting metal (often an alloy of aluminium). The blank is then machined to its final shape. The blank is arranged to form at least a crown portion of the piston but often includes the skirt and mounting portions in an integral structure. Where the structure is not integral, the skirt and/or mounting portions may be formed as one or more further blanks which are secured, eg by welding, to the blank forming the crown portion. It is also possible for the gudgeon pin to join the crown portion to the skirt portion giving an articulated piston.

The high forces and temperatures afore-mentioned to which the upper and side surface portions of the crown portion of a piston are subjected can cause problems of wear or cracking especially at the rims of the openings of the piston ring grooves. Also, many pistons have a recess, referred to as a “combustion recess”, in the upper surface of their crown portion. The combustion recess serves to modify the shape of the combustion chamber so that combustion is improved. However, it is found that the bounding surfaces of combustion recesses are prone to cracking because of the high forces and temperatures afore-mentioned. In particular, the rim around the opening of the recess is at risk. These problems of cracking can be addressed by use of an insert of high fatigue-strength or wear-resistant material which can form at least part of the bounding surface of the ring groove or of the combustion recess. Such an insert can either be cast-in, ie be placed in a cavity and have the piston blank cast around it, or be attached to the blank after casting. Both methods of providing an insert are, however, awkward. Another technique is to re-melt portions of the blank to give them a different, higher fatigue-strength micro-structure, but this is also awkward and is difficult to apply to more than a thin surface layer.

It is an object of the present invention to provide an improved method of manufacturing a piston in which a region of a material having different properties, eg high fatigue-strength or wear-resistance, from the remainder of the piston is provided in a selected surface portion of the crown portion of the piston.

The invention provides a method of manufacturing a piston for use in an internal combustion engine, the method comprising forming a blank from a first material, the blank being arranged to form at least a crown portion of the piston and having a surface portion arranged to define at least one recess, the method also comprising providing a region of a second material in said surface portion, the second material being secured to said first material, the method also comprising forming the recess in said surface portion so that the recess has a bounding surface at least part of which is formed by the second material, characterised in that said region of the second material is formed and secured to the first material by inserting a tool into the blank, bringing about relative reciprocating movement between the tool and the blank so that frictional heat is generated plasticising the material adjacent to the tool, and by causing relative translational movement between the blank and the tool while continuing the reciprocating movement therebetween so that the tool moves through said region, thereby forming the second material and mixing it with the first material at the edges of said region to secure the materials together.

In a method according to the invention, the second material can be formed, with a higher fatigue strength than the first material, and secured to the first material simply and to a readily-controlled depth. The second material may also have higher wear resistance than the first material or different properties such as thermal conductivity to the first material.

The step of forming the second material and securing it to the first material, in a method according to the invention, can utilise equipment similar to that developed by The Welding Institute of Cambridge. England, for friction welding metal components together, see eg EP 0 653 265 A.

In a method according to the invention, the recess may be a combustion recess in the upper surface portion of the crown portion or may be a piston ring groove in the side surface portion thereof. The forming and securing step may also be followed by a further such step to form a region of a third material, or a further region of the second material, and a further recess is formed with a bounding surface at least part of which is formed by the third material, or by the second material in said further region. For example, the further forming and securing step may be used to form piston ring grooves in the side surface portion of the crown portion of the piston.

It should be noted that the tool may be inserted into the same surface portion in which the recess is formed or, in some cases, the tool may be inserted into an adjacent surface portion to that in which the recess is formed and the recess may be cut through into the region of the second material. For example, when forming a ring groove, the tool may be inserted into the upper surface portion of the crown portion adjacent to the side surface portion thereof and the ring groove machined into said region.

Preferably, in a method according to the invention, the reciprocating movement of the tool is brought about by rotating the tool about an axis extending generally normally of said surface portion of the blank.

In a method according to the invention, the first and the second materials may have the same composition but differ in micro-structure. For example, the second material may be formed from the first material by the action of the tool altering the micro-structure. In this case, the blank may be cast from an alloy of aluminium having a relatively coarse micro-structure, and the tool may act to form a finer micro-structure in the second material. Alternatively, a method according to the invention may also comprise applying an additional material to said region, before said tool is inserted therein, so that said second material contains the additional material. In this case, the additional material, which may comprise fibres, metal or ceramic particles etc, alters the composition of the second material.

There now follow detailed descriptions, to be read with reference to the accompanying drawings, of four methods of manufacturing a piston which are illustrative of the invention.

In the drawings:

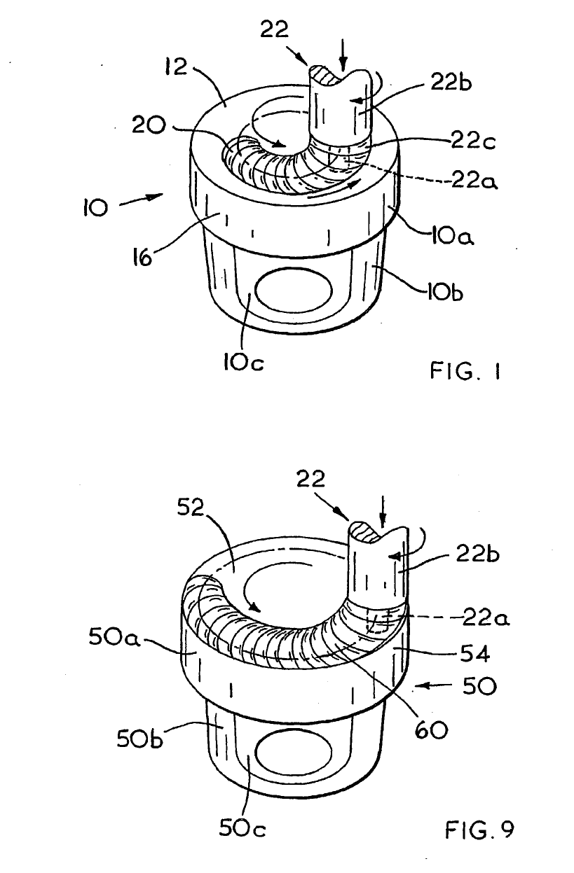

FIG. 1 is a diagrammatic perspective view of a step in a first illustrative method;

FIGS. 2 to 5 are vertical cross-sectional views taken through a blank at successive stages of the first illustrative method;

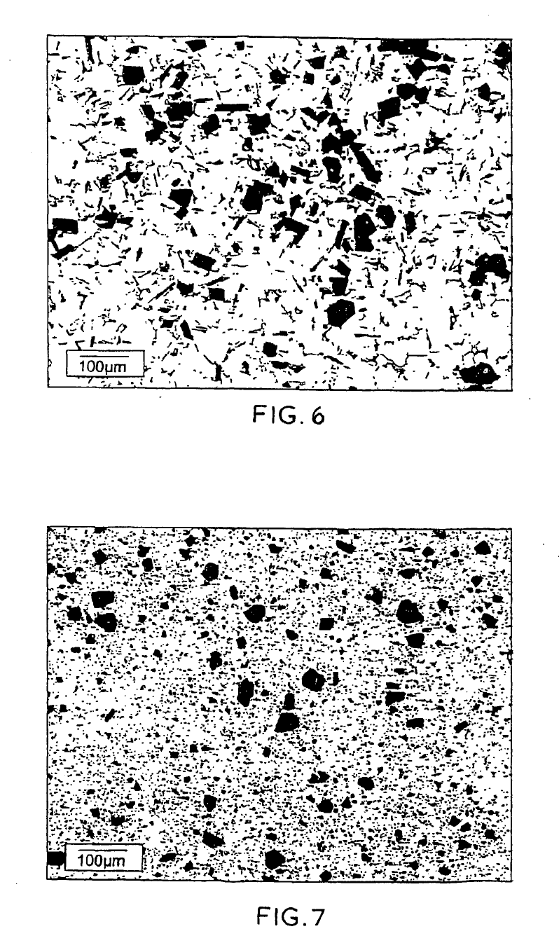

FIGS. 6 and 7 are optical micrographs illustrating the micro-structure of first and second materials formed in the first illustrative method;

FIG. 8 is a similar view to FIG. 2 but illustrating a modification of the first illustrative method;

FIG. 9 is a view similar to FIG. 1 but illustrating the second illustrative method;

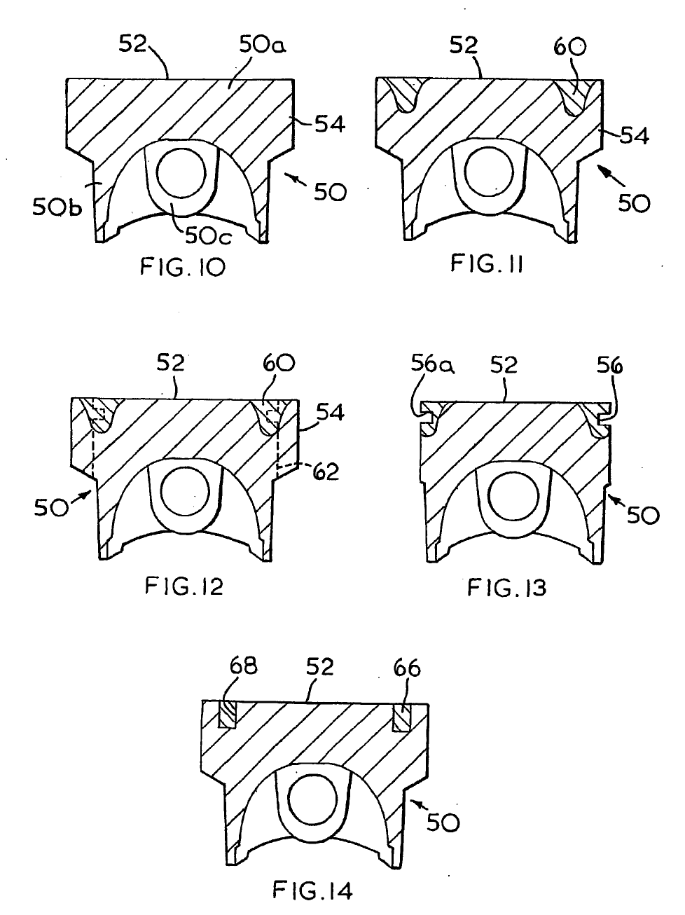

FIGS. 10 to 13 are vertical cross-sectional views illustrating successive stages of the second illustrative method;

FIG. 14 is similar to FIGS. 10 to 13 but illustrates a modification of the second illustrative method;

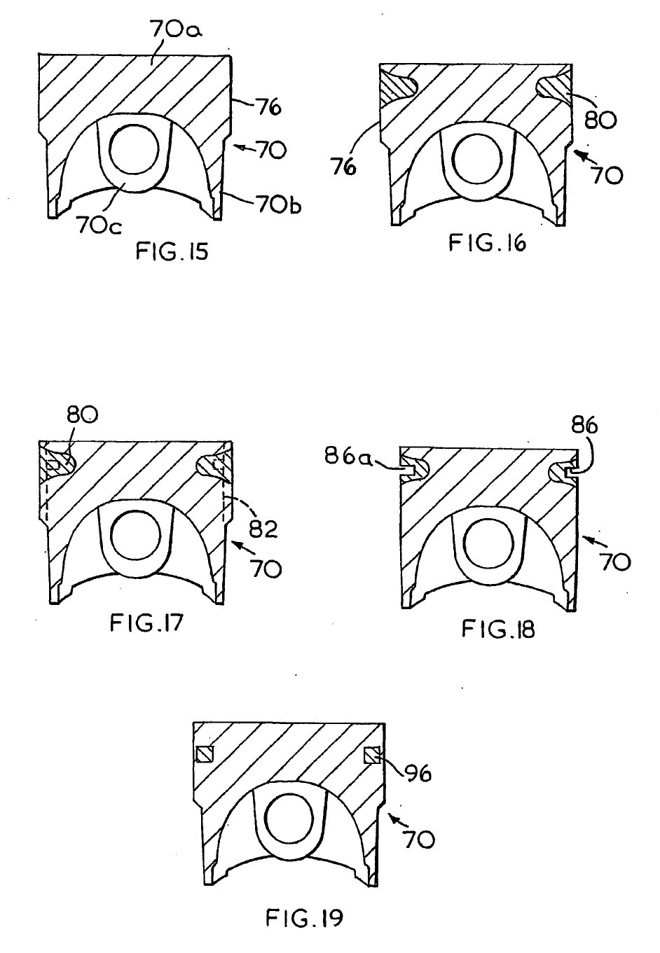

FIGS. 15 to 18 are similar to FIGS. 2 to 5 but illustrate the third illustrative method;

FIG. 19 is similar to FIGS. 15 to 18 but illustrate a modification of the third illustrative method; and

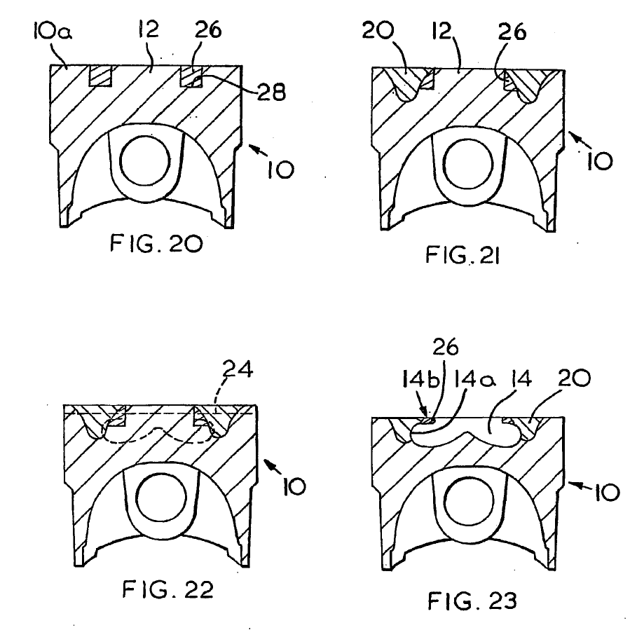

FIGS. 20 to 23 are similar to FIGS. 2 to 5 but illustrate the fourth illustrative method.

The first illustrative method, illustrated by the FIGS. 1 to 7 of the drawings, is a method of manufacturing a piston for use in an internal combustion engine. The method comprises forming a blank 10 from a first material, specifically an alloy of aluminium containing silicon and having the micro-structure shown in FIG. 6. The blank 10 has portions, 10a, 10b and 10c, arranged, respectively to form a crown portion of the piston, a skirt portion of the piston, and a mounting portion of the piston on which a gudgeon pin is mounted. The blank portion 10a has an upper surface portion 12 arranged to define a combustion recess 14 of the piston, and a side surface portion 16 arranged to define piston ring grooves of the piston.

The first illustrative method also comprises providing a region 20 of a second material, specifically the same aluminium alloy as the first material but with the finer micro-structure shown in FIG. 7. The region 20 is in the form of a closed track in the upper surface portion 12 of the blank 10. At the boundaries of the region 20, the second material is secured to said first material.

The first illustrative method also comprises forming the combustion recess 14 in the upper surface portion 12 of the blank 10 so that the recess 14 has a bounding surface 14a at least part of which is formed by the second material. In the first illustrative method, the blank 10, shown in FIG. 2, is formed by a conventional casting operation. Then, the region 20 of the second material is formed and secured to the first material by an operation which comprises first inserting a tool 22 (see FIG. 1) into the upper surface portion 12 of the blank 10. The tool 22 has a lower cylindrical portion 22a and an upper cylindrical portion 22b, of greater diameter than the portion 22a, separated from the portion 22a by a shoulder 22c. Specifically, the lower portion 22a of the tool has a diameter of 6 mm and the portion 22b has a diameter of 18 mm, the portions 22a and 22b being co-axial.

The tool 22 is first positioned so that the portion 22a enters the surface portion 12 (either into a pre-drilled hole or by displacing material plasticised by frictional heat) and the shoulder 22c rests on top of the surface portion 12. Next, in said operation, while pressing the tool 22 against the blank 10, relative reciprocating movement is brought about between the tool 22 and the blank 10 so that frictional heat is generated plasticising the material adjacent to the tool portion 22a. Frictional heat is also generated between the upper surface portion 12 and the shoulder 22c so that material adjacent to the shoulder is also plasticised. Specifically, the reciprocating movement of the tool 22 is brought about by rotating the tool 22 at 1500 rpm about an axis extending normally of said upper surface portion 12 of the blank 10, ie the common axis of the tool portions 22a and 22b. Next, in said operation, relative translational movement is caused between the blank 10 and the tool 22 while continuing the reciprocating movement therebetween so that the tool moves across said region 20 in the upper surface portion 12 of the blank 10, thereby forming the second material in said region 20 and mixing it by stirring with the first material at the edges of said region 20 to secure the materials together. The relative translational movement is brought about by moving the reciprocating tool 22 along the closed track defining the region 20 at about 100 mm per minute. This results in the blank 10 shown in FIG. 3.

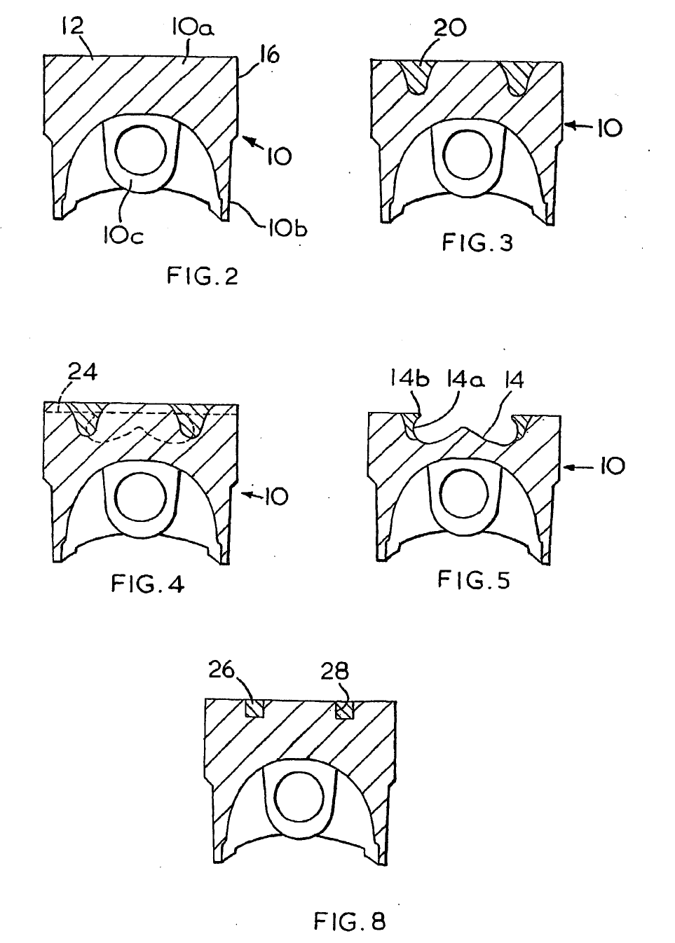

It is desirable that the tool 22 is withdrawn from the blank 10 in a portion thereof which will be removed during machining such as in the area which will be occupied by the combustion recess 14 or occupied by a excess portion metal caused by the runner system used when casting the blank. The combustion recess 14 is then formed by machining to the line 24 shown in FIG. 4 with the rim 14b of the recess 14 being formed entirely from the second material, as shown in FIG. 5.

FIG. 8 illustrates a modification of the first illustrative method in which the method also comprises applying an additional material 26 to said region 20, before said tool 22 is inserted therein, so that said second material contains the additional material. Specifically, the additional material 26 is inserted into a groove 28 formed in the region 20.

The second illustrative method, illustrated by FIGS. 9 to 13 of the drawings, is a method which is similar to the first illustrative method but is concerned with the formation of piston ring grooves rather then with the formation of a combustion recess. The method comprises forming a blank 50, from the same first material as in the first illustrative method having the micro-structure shown in FIG. 6. The blank 50 has portions 50a, 50b and 50c corresponding generally to the portions 10a, 10b and 10c of the blank 10. However, the portion 50a, which forms the crown portion of the piston, is formed with a greater diameter than is required for the finished piston (in particular the portion 50a has a greater diameter than the skirt portion 50b. The blank portion 50a has an upper surface portion 52 and a side surface portion 54 which is arranged to define a piston ring groove 56 (see FIG. 13).

The second illustrative method comprises providing a region 60 of a second material, specifically the same aluminium alloy as the first material but with the finer micro-structure shown in FIG. 7. The region 60 is in the form of a closed track in the upper surface portion 52 of the blank 50 and, at the boundaries of the region 60, the second material is secured to the first material. The region 60 differs from the region 20 of the first illustrative method in that the track followed by the region 60 is of greater diameter and is formed closer to the edge of the side surface portion 54.

The region 60 is formed by utilising the same tool 22 which is used in the first illustrative method to form the region 20 and the same speeds of rotation and translation are used. The region 60 is illustrated in cross-section in FIG. 11 in which it can be seen that the region 60 extends adjacent to the side surface portion 54 of the blank portion 50a.

The second illustrative method also comprises forming the piston ring groove 56 in the side surface portion 54 of the blank 50 so that the groove 56 has a bounding surface 56a which is formed by the second material. This is achieved by machining away the outer portion of the surface portion 54 to the line 62 shown in FIG. 12. This results in the second material of the region 60 becoming exposed in the upper portion of the side portion 54. The ring groove 56 is then machined into the second material of the region 60 resulting in the blank shown in FIG. 13.

FIG. 14 illustrates a modification of the second illustrative method in which the method also comprises applying an additional material 66 to the region 60, before the tool 22 is inserted therein. This results in the second material forming the region 60 containing the additional material 66. The additional material 66 is positioned in a groove 68 formed in the upper surface portion 52.

The third illustrative method, illustrated by FIGS. 15 to 18 of the drawings, is a method which is similar to the second illustrative method but forms the piston ring grooves differently. The method comprises forming a blank 70, from the same first material as in the first illustrative method having the micro-structure shown in FIG. 6. The blank 70 has portions 70a, 70b and 70c corresponding generally to the portions 10a, 10b and 10c of the blank 10. The blank portion 70a has a side surface portion 76 which is arranged to define a piston ring groove 86 (see FIG. 18).

The third illustrative method comprises providing a region 80 of a second material, specifically the same aluminium alloy as the first material but with the finer micro-structure shown in FIG. 7. The region 80 is in the form of a closed track which extends circumferentially around the side surface portion 76. At the boundaries of the region 80, the second material is secured to the first material. The region 80 is formed by utilising the same tool 22 which is used in the first illustrative method to form the region 20 and the same speeds of rotation and translation are used.

The third illustrative method also comprises forming the piston ring groove 86 in the side surface portion 76 of the blank 70 so that the groove 86 has a bounding surface 86a which is formed by the second material. This is achieved by machining away the outer portion of the surface portion 76 to the line 82 shown in FIG. 17. The ring groove 86 is then machined into the second material of the region 80 resulting in the blank shown in FIG. 18.

FIG. 19 illustrates a modification of the third illustrative method in which the method also comprises applying an additional material 96 to the region 80, before the tool 22 is inserted therein. This results in the second material forming the region 80 containing the additional material 96. The additional material 96 is positioned in the form of a ring which is cast into the blank 70.

The fourth illustrative method illustrated by FIGS. 20 to 23 is similar to the modification of the first illustrative method which is illustrated by FIG. 8 and the same reference numerals are used for like parts without further description.

The fourth illustrative method differs from the first illustrative method in that the additional material 26 which is inserted in the groove 28 in the surface portion 12 of the blank 10 is not completely mixed with the first material. Instead, the region 20 of second material (see FIG. 21) is formed by moving the tool 22 along a closed track which overlaps an outer edge of the additional material 26 (which is in the form of a ring) but does not overlap the inner edge of the additional material 26. This results in the surface portion 12 of the blank 10 having a central “island” of the first material, the island being surrounded by a ring of the additional material 26 which is in turn surrounded by the region 20.

The fourth illustrative method also comprises machining the crown portion 10a of the blank 10 to the line 24 shown in FIG. 22. The line 24 is arranged so that the rim 14b of the combustion recess 14 formed by the machining is formed from the additional material 26 while the remainder of the side surface of the combustion recess 14 is formed by the region 20 of the second material. The bottom of the combustion recess 14 is formed from the first material (see FIG. 23).

1. A method of manufacturing a piston for use in an internal combustion engine, the method comprising forming a blank (10; 50; 70) from a first material, the blank being arranged to form at least a crown portion (10a; 50a; 70a) of the piston and having a surface portion (12; 52; 54) arranged to define at least one recess, (14; 28; 56; 68; 86) the method also comprising providing a region of a second material (20; 60; 80) in said surface portion, the second material being secured to said first material, the method also comprising forming the recess in said surface portion so that the recess has a bounding surface (14a; 56a; 86a) at least part of which is formed by the second material, characterised in that said region of the second material is formed and secured to the first material by inserting a tool (22) into the blank, bringing about relative reciprocating movement between the tool and the blank so that frictional heat is generated plasticising the material adjacent to the tool, and by causing relative translational movement between the blank and the tool while continuing the reciprocating movement therebetween so that the tool moves through said region of the blank, thereby forming the second material and mixing it with the first material at the edges of said region to secure the materials together:

2. A method according to claim 1, characterised in that the recess (14) is a combustion recess in the upper surface portion (12) of the crown portion (10a).

3. A method according to claim 1, characterised in that the recess (56; 86) is a piston ring groove in the side surface portion (54) of the crown portion.

4. A method according to either one of claims 2 or 3, characterised in that the forming and securing step is followed by a further such step to form a region of a third material, or a further region of the second material (20, 60, 80), and a further recess is formed with a bounding surface at least part of which is formed by the third material, or by the second material in said further region.

5. A method according to any one of claims 1 to 4, characterised in that the reciprocating movement of the tool (22) is brought about by rotating the tool about an axis extending generally normally of said surface portion of the blank (10; 50; 70).

6. A method according to any one of claims 1 to 5, characterised in that the first and the second materials have the same composition but differ in micro-structure.

7. A method according to any one of claims 1 to 5, characterised in that the method also comprises applying an additional material (26; 66; 96) to said region (20; 60; 80), before said tool is inserted therein, so that said second material contains the additional material.

8. A piston manufactured by a method according to any one of claims 1 to 8.
